(19) United States
(12) Patent Application Publication
(10) Pub. No.: US 2026/0080325 A1
(43) Pub. Date: Mar. 19, 2026

(54) SYSTEM AND METHOD FOR GENERATION AND USE OF DATA MODELS FOR DETERMINATION OF INFERRED SKILLS

(71) Applicant: ORACLE INTERNATIONAL CORPORATION, Redwood Shores, CA (US)

(72) Inventors: Gunvansh Khanna, Edison, NJ (US); Manisha Gupta, San Ramon, CA (US); Shekhar Agrawal, Austin, TX (US); Yvette Cameron, Denver, CO (US)

(21) Appl. No.: 18/886,009

(22) Filed: Sep. 16, 2024

(51) Int. Cl. G06Q 10/0631; G06Q 10/1053

(52) U.S. Cl. CPC G06Q 10/063112; G06Q 10/1053

(57) ABSTRACT

Embodiments described herein are generally directed to computer-based data analytics and the processing of enterprise data, including the generation and use of data models for determining inferred characteristics associated with candidates. In accordance with an embodiment, the system utilizes data-processing pipelines and machine learning models to process structured, semi-structured, and/or unstructured sets of data, received from various sources; generate a multi-dimensional ontology and a taxonomy associated with the characteristics of open positions or potential candidates; identify, based on the data models, one or more additional or inferred characteristics associated with the candidates; and present the output by way of an analytics dashboard, scorecard, or other data visualization.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally directed to computer-based data analytics and the use of data models for determining inferred characteristics associated with candidates, for example inferred skills, for display within or as part of analytics dashboards, scorecards, or other data visualizations.

### BACKGROUND

Generally described, within an enterprise organization, data analytics enables the computer-based examination of amounts of data, to derive conclusions or other information from the data.

For example, business intelligence software tools can be used to provide the organization with information describing their enterprise data, in a format that enables users to make strategic business decisions.

Examples of the types of data analytics of interest to organizations include those directed to Enterprise Resource Planning (ERP), Human Capital Management (HCM), or Human Resources (HR), which can be used to address various use cases. For example, an HCM/HR system can be used within an organization to maintain a database of information descriptive of the organization's employees and their particular work-related skills.

However, in some organizations, the information associated with each employee in an HCM/HR system or database, for example as part of the employee's talent profile, may not be updated on a sufficiently-regular basis to accurately describe ongoing updates to the employee's known or potential skill-set. This makes it challenging for an organization's HCM/HR department or its business leaders to properly assess their workforce's overall skills, or to identify potential skill gaps that may need to be addressed.

### SUMMARY

Embodiments described herein are generally directed to computer-based data analytics and the processing of enterprise data, including the generation and use of data models for determining inferred characteristics associated with candidates.

In accordance with an embodiment, data-processing pipelines comprising artificial intelligence or machine learning (AI/ML) data models are used to process structured, semi-structured, and/or unstructured sets of data, received from various sources; generate a multi-dimensional ontology and a taxonomy associated with the characteristics of open positions or potential candidates; identify, based on the data models, one or more additional or inferred characteristics associated with the candidates; and present the output by way of an analytics dashboard, scorecard, or other data visualization.

For example, in accordance with an embodiment, the described approach can be used to identify a candidate's otherwise-hidden or inferred skills, which in turn provides an organization's HCM/HR department and business leaders with a more complete understanding of their workforce's overall capabilities. Data visualizations can be used, for example, to identify employee skills suitable for planned projects or business goals, undertake initiatives to address potential skill gaps, or support particular groups of employees in their ongoing skill development.

### BRIEF DESCRIPTION OF THE DRAWINGS

FIG. 1 illustrates an example data analytics environment, in accordance with an embodiment.

FIG. 2 further illustrates an example data analytics environment, in accordance with an embodiment.

FIG. 3 further illustrates an example data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 illustrates an example use of a data analytics environment to provide a visualization of key performance indicators or scorecards, in accordance with an embodiment.

FIG. 8 illustrates a system for generation and use of data models for determination of inferred characteristics, in accordance with an embodiment.

FIG. 9 illustrates how the system can assess structured, semi-structured, and/or unstructured data, in accordance with an embodiment.

FIG. 10 illustrates an overview of how the system uses AI/ML models to determine inferred characteristics, in accordance with an embodiment.

FIG. 11 further illustrates a system for generation and use of data models for determination of inferred characteristics, in accordance with an embodiment.

FIG. 12 further illustrates a system for generation and use of data models for determination of inferred characteristics, in accordance with an embodiment.

FIG. 13 illustrates how the system can generate data visualizations of inferred characteristics, for example, inferred skills associated with candidates, in accordance with an embodiment.

FIG. 14 further illustrates how the system can generate data visualizations, in accordance with an embodiment.

FIG. 15 further illustrates how the system can generate data visualizations, in accordance with an embodiment.

FIG. 16 further illustrates how the system can generate data visualizations, in accordance with an embodiment.

FIG. 17 further illustrates how the system can generate data visualizations, in accordance with an embodiment.

FIG. 18 further illustrates how the system can generate data visualizations, in accordance with an embodiment.

FIG. 19 illustrates an example process or method for generation and use of data models for determination of inferred characteristics associated with candidates, in accordance with an embodiment.

FIG. 20 illustrates an example use case of determining inferred skills, in accordance with an embodiment.

FIG. 21 further illustrates an example use case of determining inferred skills, in accordance with an embodiment.

FIG. 22 further illustrates an example use case of determining inferred skills, in accordance with an embodiment.

FIG. 23 further illustrates an example use case of determining inferred skills, in accordance with an embodiment.

FIG. 24 further illustrates an example use case of determining inferred skills, in accordance with an embodiment.

FIG. 25 further illustrates an example use case of determining inferred skills, in accordance with an embodiment.

### DETAILED DESCRIPTION

Generally described, within an enterprise organization, data analytics enables the computer-based examination of amounts of data, to derive conclusions or other information from the data.

For example, business intelligence software tools can be used to provide the organization with information describing their enterprise data, in a format that enables users to make strategic business decisions.

Examples of the types of data analytics of interest to organizations include those directed to Enterprise Resource Planning (ERP), Human Capital Management (HCM), or Human Resources (HR), which can be used to address various use cases. For example, an HCM/HR system can be used within an organization to maintain a database of information descriptive of the organization's employees and their particular work-related skills.

Increasingly, a data analytics environment can be provided within the context of software-as-a-service (SaaS) or cloud-based enterprise software environments, such as, for example, an Oracle Fusion Applications, Oracle Analytics Cloud or Fusion Analytics Warehouse (FAW) environment.

### Data Analytics Environments

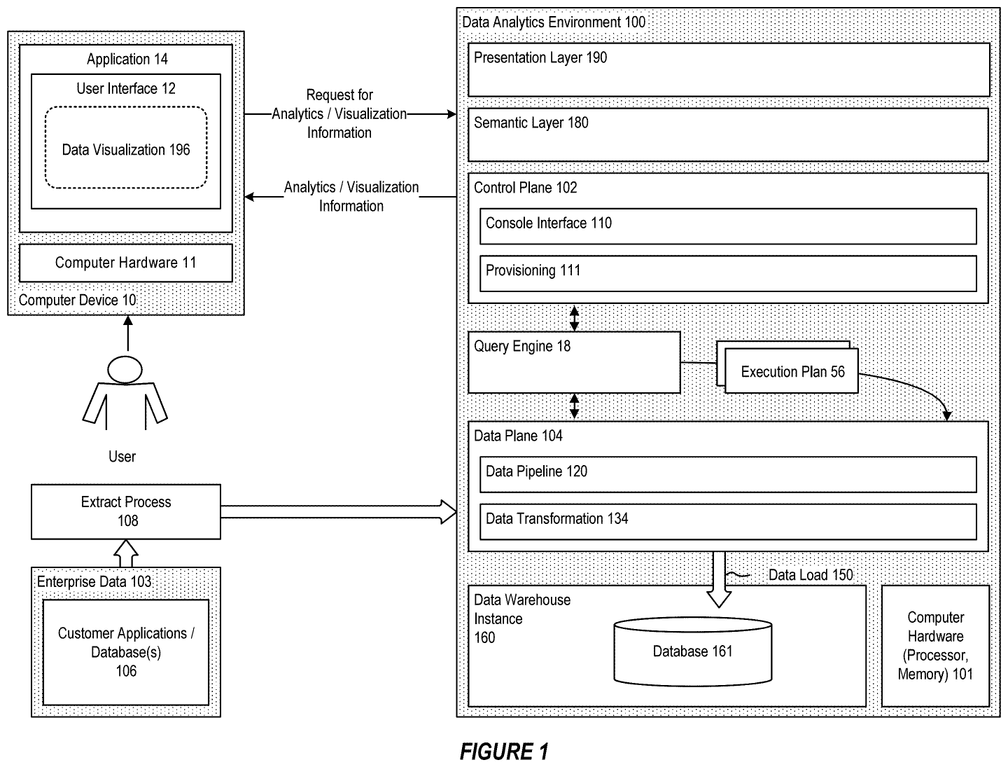

FIG. 1 illustrates an example data analytics environment, in accordance with an embodiment.

The embodiment illustrated in FIG. 1 is provided for illustrating an example data analytics environment in association with which various embodiments described herein can be used. The components and processes illustrated in FIG. 1 and as described elsewhere herein with regard to various other embodiments, can be provided as software or program code executable by, for example, a cloud computing system, or other suitably-programmed computer system.

As illustrated in FIG. 1, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract data from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

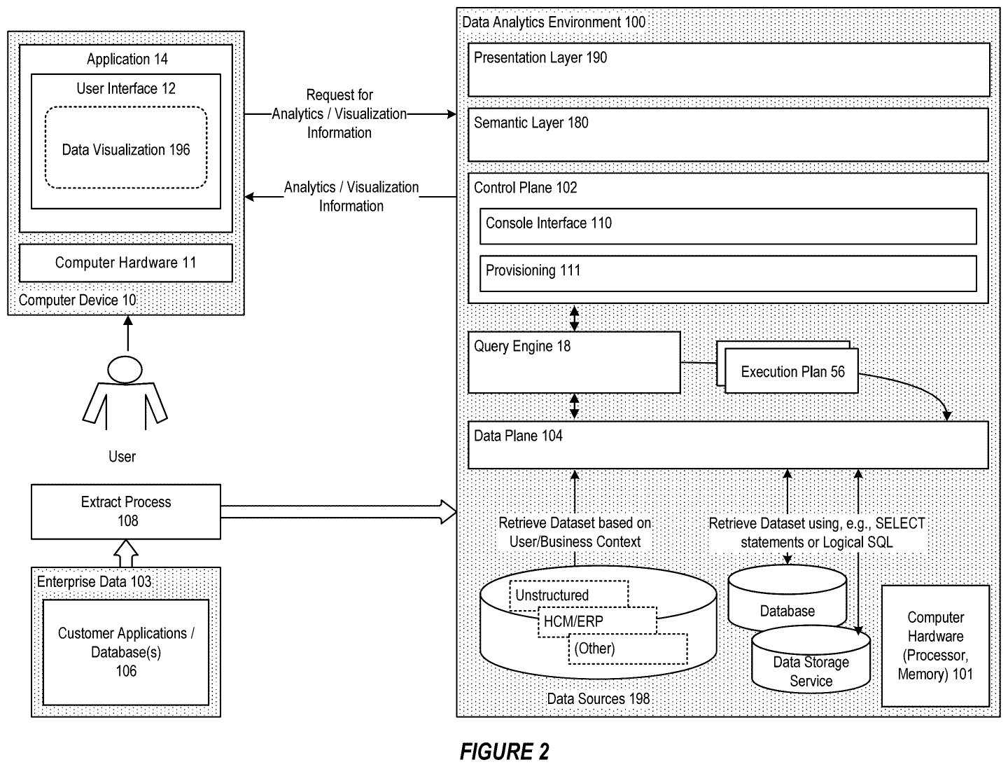

FIG. 2 further illustrates an example data analytics environment, in accordance with an embodiment.

As illustrated in FIG. 2, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

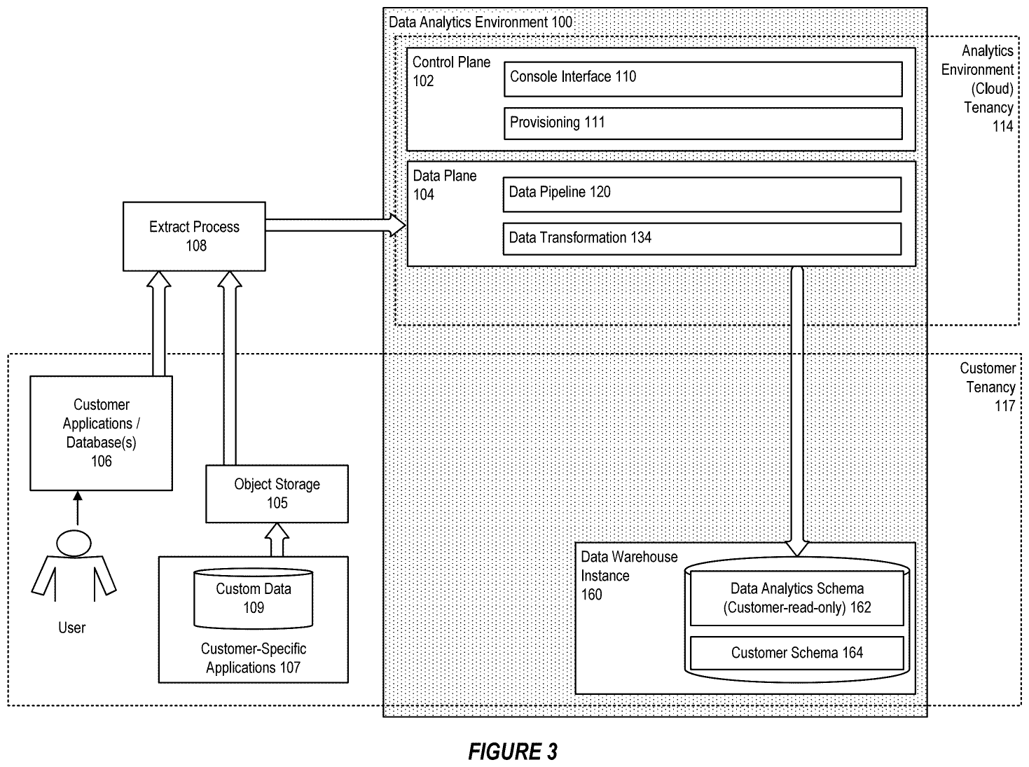

FIG. 3 further illustrates an example data analytics environment, in accordance with an embodiment.

As illustrated in FIG. 3, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

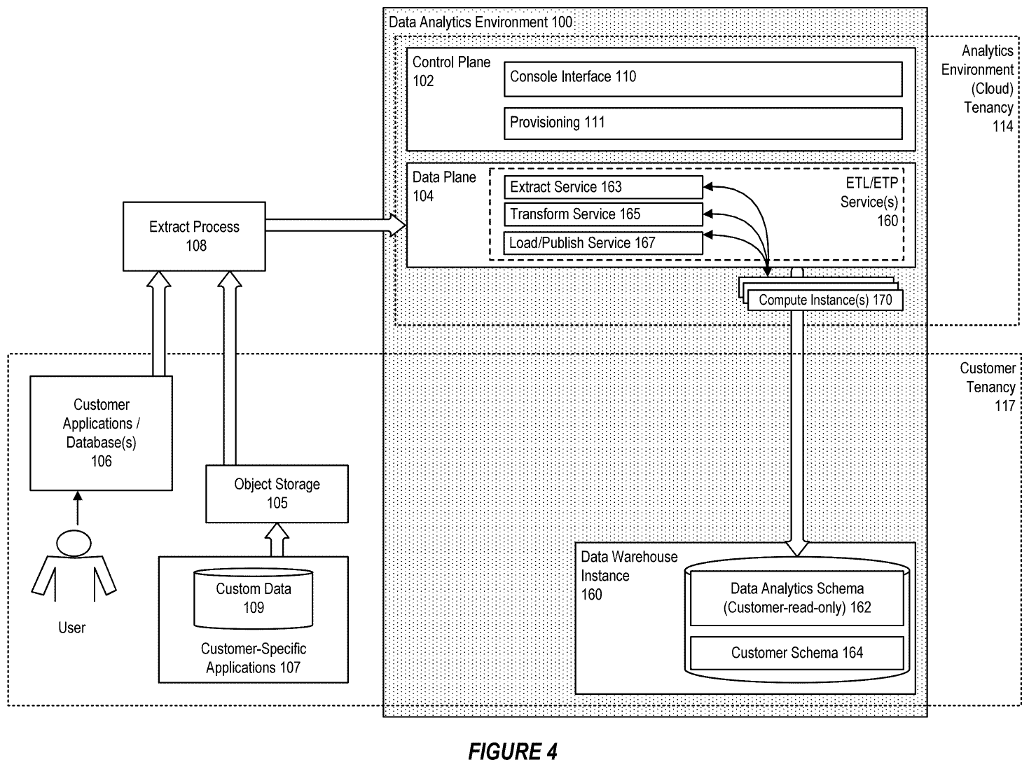

FIG. 4 further illustrates an example data analytics environment, in accordance with an embodiment.

As illustrated in FIG. 4, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

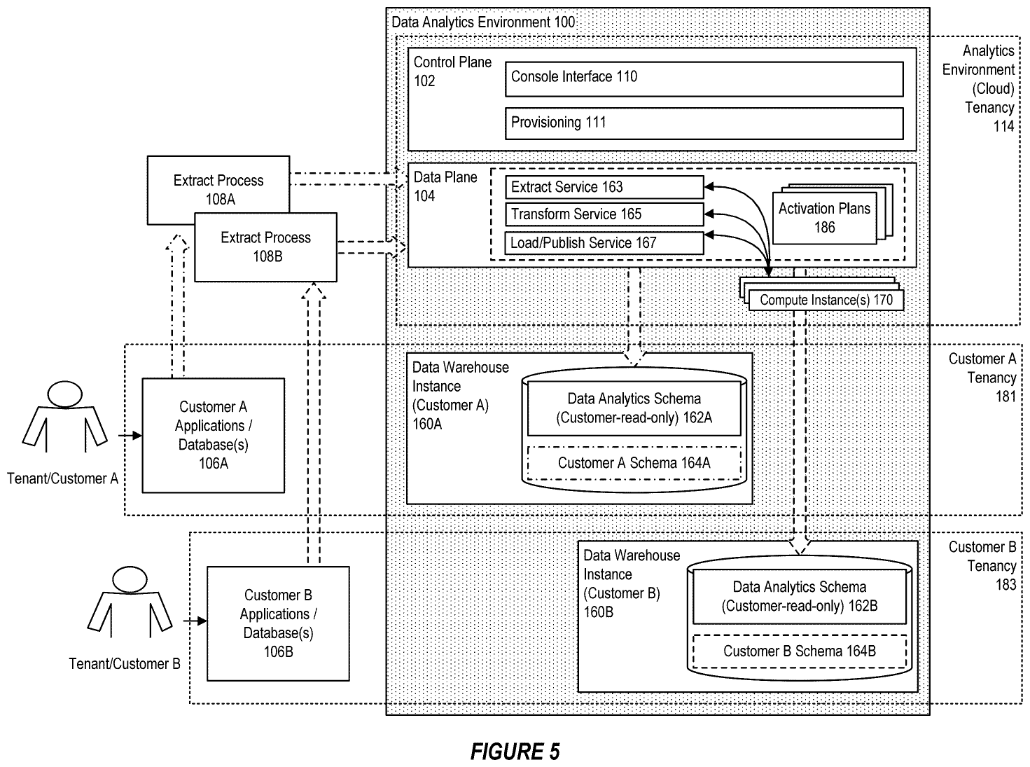

FIG. 5 further illustrates an example data analytics environment, in accordance with an embodiment.

As illustrated in FIG. 5, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

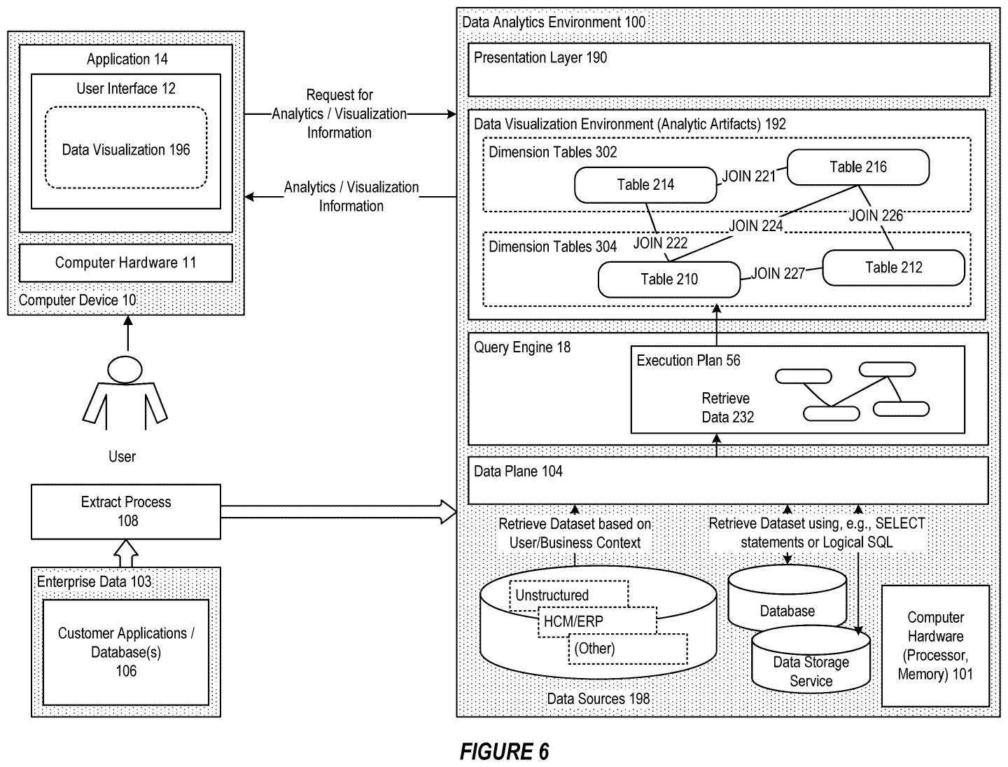

FIG. 6 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 6, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Analytics Dashboards, Scorecard, and Other Data Visualizations

As described above, business intelligence software tools can be used to provide an organization with information describing their enterprise data, in a format that enables users to make strategic business decisions; with examples of the types of data analytics of interest including those directed to Enterprise Resource Planning (ERP), Human Capital Management (HCM), or Human Resources (HR)

In some environments, a variety of key measures or metrics are used to assess, quantify, or provide an indication of the effectiveness of an organization group. For example, a team effectiveness KPI can be used to measure effectiveness of a particular team by assessing its attrition rate, cost, requisition filling rate, or engagement survey score etc., of the team in comparison with the rest of the organization. Such key measures help executives to identify specific managers with high performing teams, and/or assess potential areas of improvement.

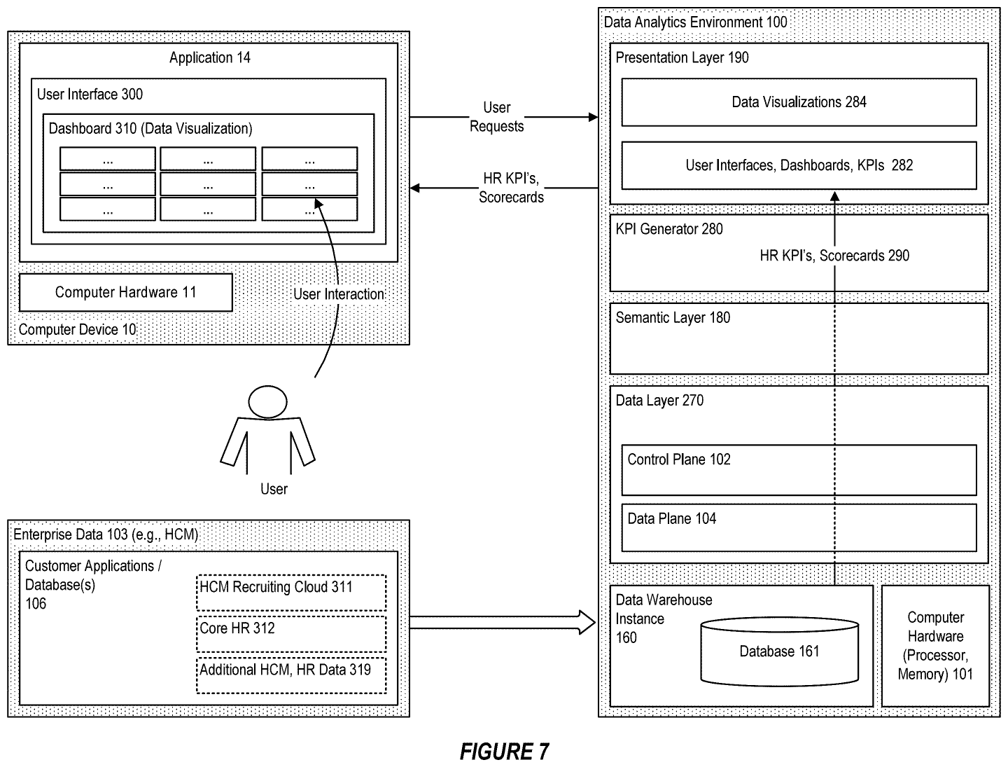

FIG. 7 illustrates an example use of a data analytics environment to provide a visualization of key performance indicators or scorecards, in accordance with an embodiment.

As illustrated in FIG. 7, in accordance with an embodiment, a data analytics environment, for example as described above, can include a KPI generator 280 that receives information via a data layer 270 from a data warehouse instance, and enables generation of enterprise data (e.g., HCM/HR) KPIs 290 as analytics dashboards, scorecard, or other data visualizations associated with the enterprise organization.

In accordance with an embodiment, the system can be accessed by a user using a client computer device, for example as described above. In response to a request, the system can receive, from a data warehouse instance, an (e.g., HCM/HR) enterprise data, and generate a user interface, analytics dashboard, or KPI 282, for use as one or more data visualizations 284, and for subsequent display at a client user interface 300, for example as a two-dimensional analytics dashboard, scorecard, or other data visualization format 310.

For example, when used with HCM/HR enterprise data, such data can include for example, a recruiting cloud data 311, HR core data 312, or additional HR data 319, as further described below.

In accordance with various embodiments, the teachings described herein can be used with various systems and methods for providing or supporting the use of data analytics or KPIs, such as, for example, the systems and methods described in U.S. Patent Application titled “SYSTEM AND METHOD FOR DATA ANALYTICS WITH AN ANALYTIC APPLICATIONS ENVIRONMENT”, application Ser. No. 16/862,394, filed Apr. 29, 2020, and subsequently published as U.S. Patent Application Publication No. 2020/0349155 on Nov. 5, 2020; or U.S. Patent Application titled “TECHNIQUES FOR DATA-DRIVEN CORRELATION OF METRICS”, application Ser. No. 16/586,347, filed Sep. 27, 2019, and subsequently published as U.S. Patent Application Publication No. 2020/0104775 on Apr. 2, 2020; each of which patent applications and the contents thereof are herein incorporated by reference.

### Determination of Inferred Characteristics

As described above by way of example, an HCM/HR system can be used within an organization to maintain a database of information descriptive of the organization's employees and their particular work-related skills.

However, in some organizations, the information associated with each employee in an HCM/HR system or database, for example as part of the employee's talent profile, may not be updated on a sufficiently-regular basis to accurately describe ongoing updates to the employee's known or potential skill-set. This makes it challenging for an organization's HCM/HR department or its business leaders to properly assess their workforce's overall skills, or to identify potential skill gaps that may need to be addressed.

For example, although a HCM system may offer a means by which employees can describe their current skills, which forms part of the employee's talent profile-this generally requires the employees to be proactive in updating their talent profiles as they take on new types of projects, receive further training, or learn new skills.

Within a particular industry, traditional job titles may evolve to encompass new duties; and employees with the same job title might have expanded their skills in different directions beyond those initially required of the position.

Different job titles may also be used for otherwise similar positions, such that relying on the use of job titles may not provide a clear indication of the underlying responsibilities.

For open positions, there be a large number of job applicants or candidates, and with the variety of different ways in which candidates might describe their former jobs and skills, finding the most appropriate candidate can be time-consuming.

To address the above aspects, in accordance with an embodiment, data-processing pipelines comprising artificial intelligence or machine learning (AI/ML) data models are used to process structured, semi-structured, and/or unstructured sets of data, received from various sources; generate a multi-dimensional ontology and a taxonomy associated with the characteristics of open positions or potential candidates; identify, based on the data models, one or more additional or inferred characteristics associated with the candidates; and present the output by way of an analytics dashboard, scorecard, or other data visualization.

For example, in accordance with an embodiment, the described approach can be used to identify a candidate's otherwise-hidden or inferred skills, which in turn provides an organization's HCM/HR department and business leaders with a more complete understanding of their workforce's overall capabilities. Data visualizations can be used, for example, to identify employee skills suitable for planned projects or business goals, undertake initiatives to address potential skill gaps, or support particular groups of employees in their ongoing skill development.

In accordance with an embodiment, the system can identify, enrich, and augment an identification of existing skills based on data received from diverse sources, automatically uncovering otherwise-hidden skills for the benefit of individual employees and the organization as a whole. For example, as further described herein, the system can be used to determine any combination of one or more:

Existing skills, which are generally those skills associated with a candidate and which may be found on the candidate's talent profile.

Inferred skills, which are generally skills that may not be found on the candidate's talent profile; however the system indicates, based on a particular (e.g., data analytics, HCM/HR) customer's data and requirements, that such skills should be included on their talent profile.

Suggested skills, which are generally skills that likewise may not be found on the candidate's talent profile, however the system indicates, based on based on a particular (e.g., data analytics, HCM/HR) customer's data and requirements, along with additional external data such as that provided by a recruiting environment or by external job applicants or candidates, that such skills should be included on their talent profile.

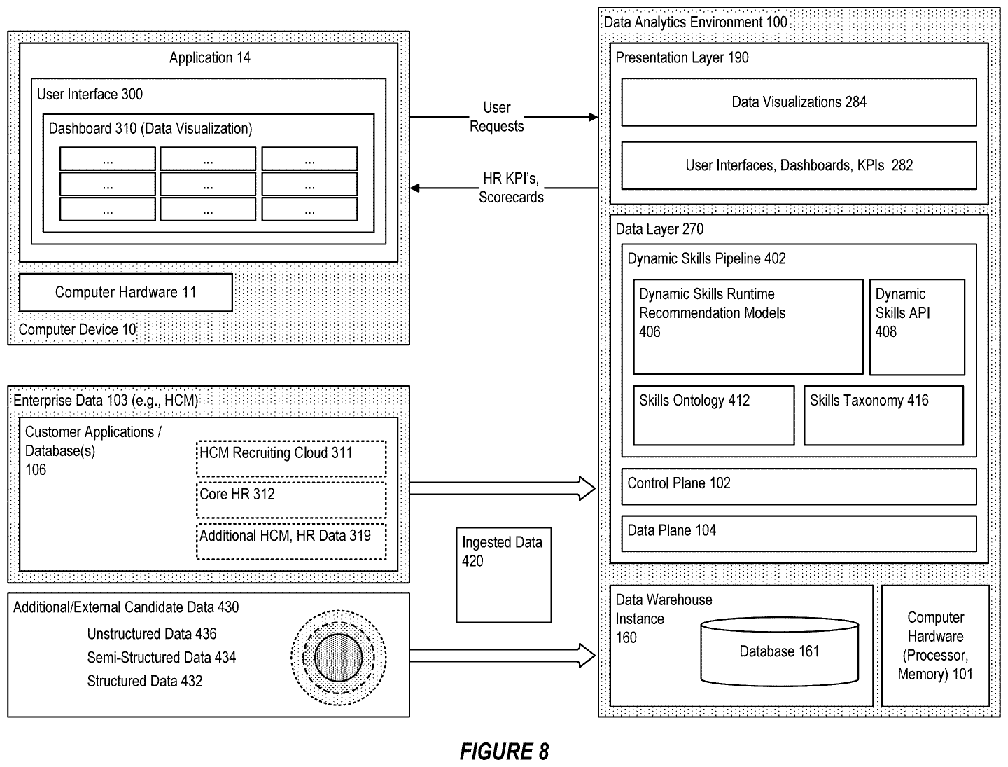

FIG. 8 illustrates a system for generation and use of data models for determination of inferred characteristics, in accordance with an embodiment.

Generally described, the determination of a candidate's inferred characteristics (for example, their inferred skills) is a two-step process, including:

In a first step: extracting an initial skills-related data from one or more provide text documents, using AI/ML data models; and

In a second step: after extracting the skills-related data, using statistical techniques to predict inferred skills for particular candidates.

As illustrated in FIG. 8, In accordance with an embodiment, the system comprises a dynamic skills pipeline 402 that includes a plurality of dynamic skills runtime recommendation models 406, that operate together to process an ingested data; and a dynamic skills API 408 by which an indication of inferred characteristics, for example inferred skills, can be surfaced to other components, for example to generate an analytics dashboard, scorecard, or other data visualization.

In accordance with an embodiment, to support the determination of inferred skills, the system further comprises a skills ontology 412, providing a framework for assessing job-titles-to-skills relationships; and a skills taxonomy 416, providing a framework for assessing skills-to-skills relationships.

In accordance with an embodiment, the dynamic skills pipeline operates on an ingested data 420, which can include both structured data such as HCM/HR enterprise data, recruiting cloud data, HR core data, or additional HR data, as described above; and can also include various or additional structured data 432, semi-structured data 434, and/or un-structured data 436 received from various sources as additional/external candidate data 430.

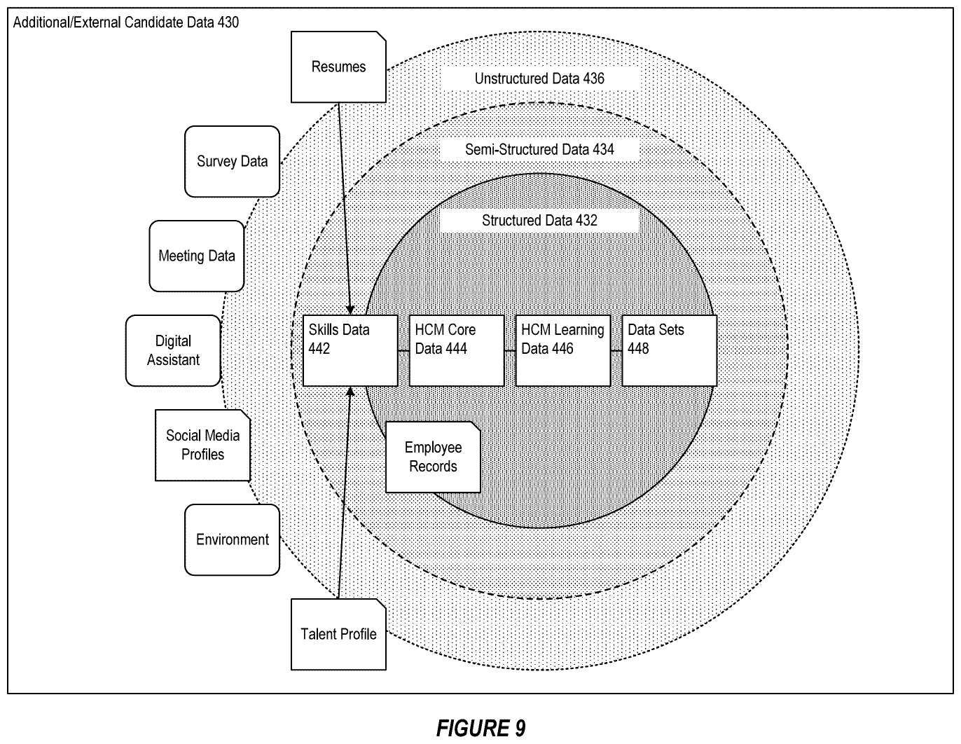

FIG. 9 illustrates how the system can assess structured, semi-structured, and/or unstructured data, in accordance with an embodiment.

As illustrated in FIG. 9, in accordance with an embodiment, additional examples of structured data that may be relevant to the determination of a candidate's inferred skills can include HCM/HR enterprise data such as HCM core data 444, HCM learning data 446, or additional HCM/HR datasets.

In accordance with an embodiment, examples of semi-structured data that may be relevant to the determination of a candidate's inferred skills can include their skills data 442 as populated, for example, by their submitted resume or a talent profile.

In accordance with an embodiment, examples of un-structured data that may be relevant to the determination of a candidate's inferred skills can include, for example, their social media profiles, or response to surveys.

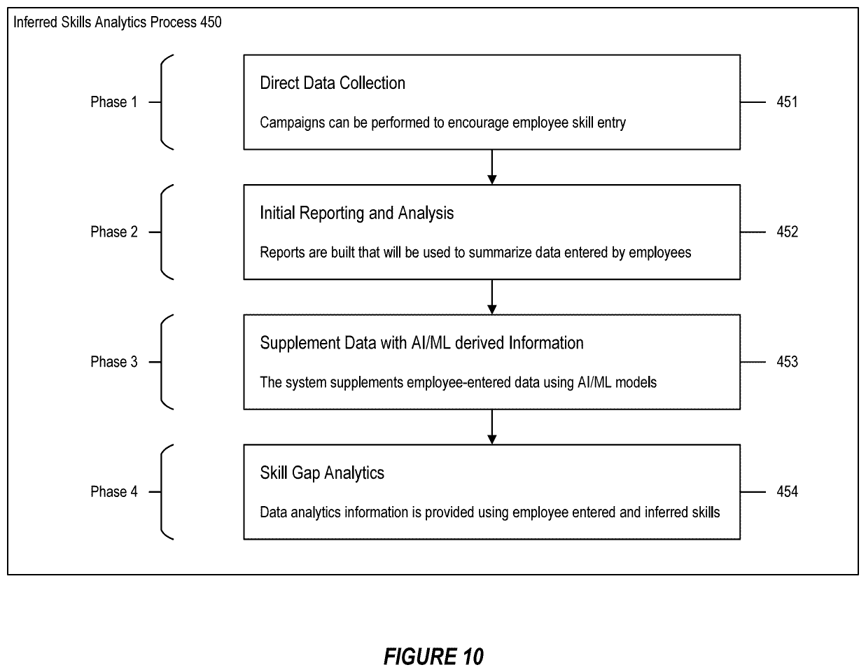

FIG. 10 illustrates an overview of how the system uses AI/ML data models to determine inferred characteristics, in accordance with an embodiment.

As illustrated in FIG. 10, in accordance with an embodiment, during a first phase (451) of the process, direct data collection campaigns can be used, for example, to encourage employee skill entry.

During a second phase (452) of the process, an initial reporting and analysis can be used to determine those reports that will be used to summarize data entered by employees.

During a third phase (452) of the process, the system can supplement employee-entered data using AI/ML data models.

During a fourth phase (451) of the process, using skill gap analytics or similar techniques, the system can provide data analytics information using employee entered and inferred skills.

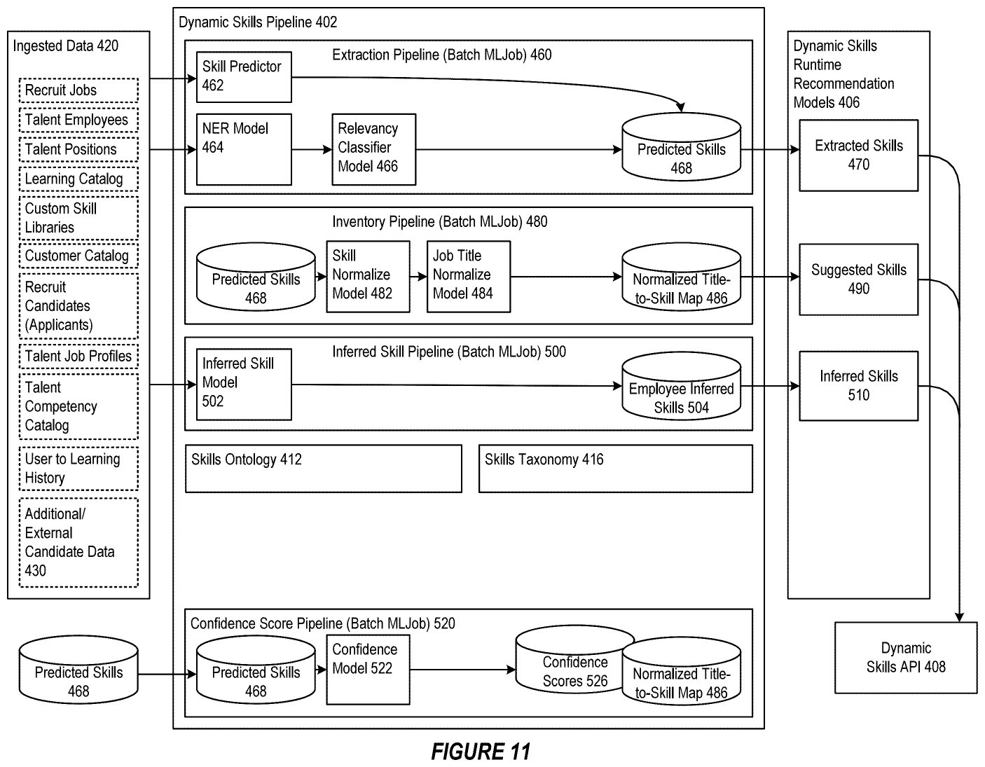

FIG. 11 further illustrates a system for generation and use of data models for determination of inferred characteristics, in accordance with an embodiment.

As illustrated in FIG. 11, in accordance with an embodiment, the dynamic skills pipeline includes a plurality of pipelines and data models that operate on ingested data, and provide an indication of extracted skills, suggested skills, and/or inferred skills to the dynamic skills API, for surfacing and use by other components, for example to generate an analytics dashboard, scorecard, or other data visualization.

In accordance with an embodiment, the pipelines can include, for example an extraction pipeline 460, comprising a skill predictor 462, named entity recognition (NER) Model 464, relevancy classifier model 466, and industry classifier model 467, that are used by the system determine a corpus of predicted skills 468, and thereafter provide to the dynamic skills API an extracted skills data 470 associated with one or more candidates.

In accordance with an embodiment, an inventory pipeline 480 comprising a skill normalize model 482, and job title normalize model 484, can be used to determine a normalized title-to-skill map 486, and thereafter provide to the dynamic skills API a suggested skills data 490 associated with the one or more candidates.

In accordance with an embodiment, an inferred skill pipeline 500 comprising an inferred skill model 502 can be used to determine an employee's inferred skills 504, and thereafter provide to the dynamic skills API an inferred skills data 510 associated with the one or more candidates.

In accordance with an embodiment, additional pipelines, such as a confidence score pipeline 520 comprising a confidence model 522 can be used to determine confidence scores 526 associated with the normalized title-to-skill map ore other aspects of the process.

In accordance with an embodiment, the pipelines of data models can be used to create, populate, and update the skills ontology and skills taxonomy.

In accordance with an embodiment, the system can then operate, for example on a position requisition dataset that indicates one or more skills of interest; and a talent profiles dataset that indicates skills associated with one or more candidates'talent profiles. The skills ontology and skills taxonomy can be overlaid onto the (position requisition and talent profiles) datasets, to determine with a measure of confidence which particular candidates may have likely or inferred skills matching the skills of interest associated with a particular job requisition.

In accordance with an embodiment, for a particular candidate, based on the examination of such data, the system can determine one or more suggested or inferred skills for the candidate, and recommend that the skills be added to their talent profile, for present or future use.

In accordance with an embodiment, during development of the system for a particular organization, the dynamic skills pipeline can be initially trained on an organization's existing databases of job requisitions, to provide an initial skills ontology, skills taxonomy, and data models that are well-suited to that organization's particular environment, The data models can then be updated on a regular basis from that point forward. Generally the system is operated so as to determine inferred skills on a batch basis, for many or all of an organization's employees at a time, providing an overall view into any skill gaps within the organization.

### Dynamic Skills AI/ML Data Models

In accordance with an embodiment, the data models used to extract skills from an ingested data, for example a given text document, can include:

### Named Entity Recognition (NER) Model

In accordance with an embodiment, the named entity recognition (NER) model is a deep learning language contextual model; the purpose of which is to extract seen and unseen skills from a given text document.

In accordance with an embodiment, the data model can be trained on historical job requisitions, which can be manually-tagged with a set of known skills. The data model is then trained to learn the grammatical usage of skills in a text document. Once trained, the data model is capable of identifying “new and unseen skills” from any given text document.

In accordance with an embodiment, the input to the data model is a text in paragraph form; and the model output is list of skills mentioned in the paragraph.

### Relevancy Classifier Model

In accordance with an embodiment, the relevancy classifier model is a binary classifier, the purpose of which is to predict the correctness of skills extracted by the NER model.

In accordance with an embodiment, the data model can be trained on manually-labeled positive and negative samples provided by NER predictions.

In accordance with an embodiment, the input to the data model is a pair of sentence and skill in the sentence as predicted by the NER model; and the model output is an indication of true/false.

### Skill Normalizer Model

In accordance with an embodiment, the skill normalizer model is a language grammatical model, the purpose of which is to identify the best form of a skills given millions of skills.

In accordance with an embodiment, the data model can be trained using a two-step approach:

In a first step, the system groups skills syntactically and semantically. Syntactical grouping can be performed according to grammatical rules; and semantic grouping can be performed by an in-house trained embedding (e.g., doc2vec) model. For example, [managed people and people management] skills can be grouped syntactically using grammatical rules; whereas [margin lending and margin financing] skills can be grouped semantically using vector embedding models.

In a second step, once the group is formed, the system operates to predict the best form of skill within the group; and the remaining skills in that group become variants. This can be accomplished by observing the frequencies at which these skills appear in a data corpus overlaid by an un-contextual grammar model. For example, in an example group [MS Excel, Microsoft Excel, Excel 365], the data model may elect to treat [Microsoft Excel] as the normalized form and the remainder of the terms as variants.

In accordance with an embodiment, the input to the data model input is a corpus (a large amount, e.g., a million) skills; and the model output is the normalized forms of those skills and their variants.

### Job Title Normalizer Model

In accordance with an embodiment, the job title normalizer model is a vector similarity-based model, the purpose of which is to convert a given job title to its normalized form, removing noise and identifying seniority. The normalized forms of titles can be based on an industry-recognized nomenclature of occupations such as that defined by the European Skills, Competences, Qualifications and Occupations (ESCO) or the U.S. Occupational Information Network (O*NET) programs.

In accordance with an embodiment, the data model can be trained using a multi-step approach:

Remove noise: in this step, the NER model is trained to extract person/place/time entities which are considered noise; for example in [software developer-Austin], the reference to Austin in this example may not be needed.

Identifying seniority: a fuzzy match seniority of keywords is performed using a pre-curated list of seniority keywords; for example in [sr. software developer, senior software developer], the keywords sr. and senior in this example are extracted and added at the end.

Semantic similarity: a semantic similarity comparison with, e.g., the ESCO/O*NET job titles, is performed by an in-house trained embedding (e.g., doc2vec) model.

In accordance with an embodiment, the input to the model is a job title; and the model output is the normalized forms of the job title.

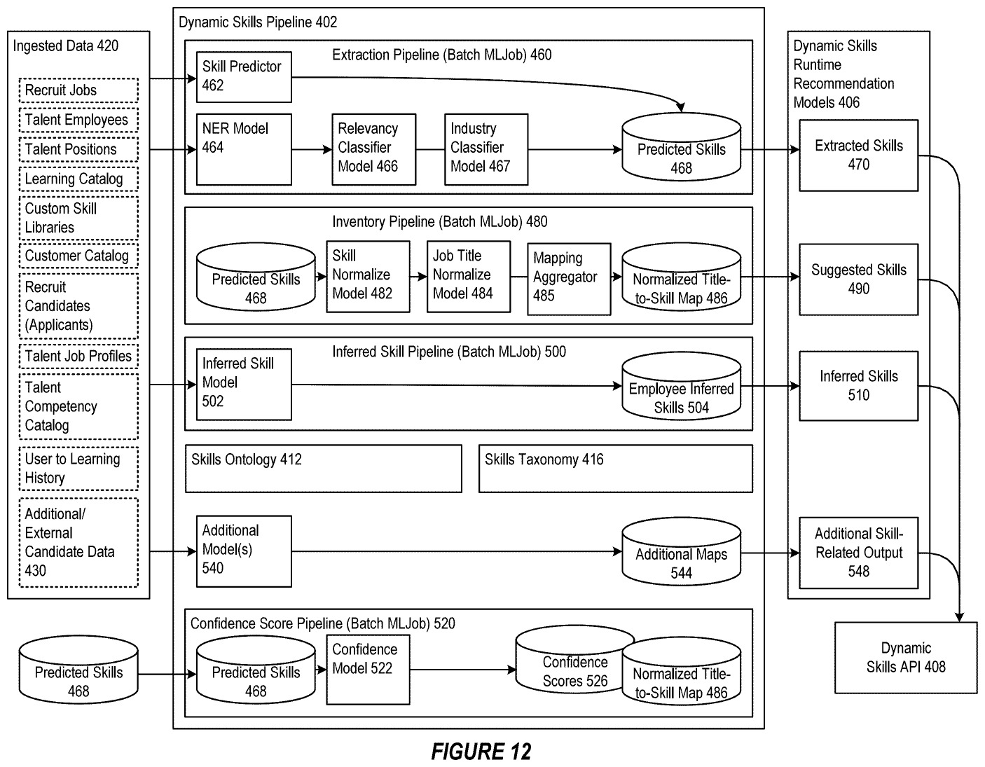

FIG. 12 further illustrates a system for generation and use of data models for determination of inferred characteristics, in accordance with an embodiment.

As illustrated in FIG. 12, in accordance with an embodiment, the system can include additional models as needed to address particular use cases, such as, for example, an industry classifier model 467, mapping aggregator 485, and/or additional models 540 and skill-related maps 544, that can be used to provide additional skill-related output 548.

The above example of data models and their operation, including the training of the various data models, model inputs, and model outputs, are provided by way of example. In accordance with various embodiments, additional types of data models can be used to address particular use cases.

### Data Visualization Analytics Dashboard

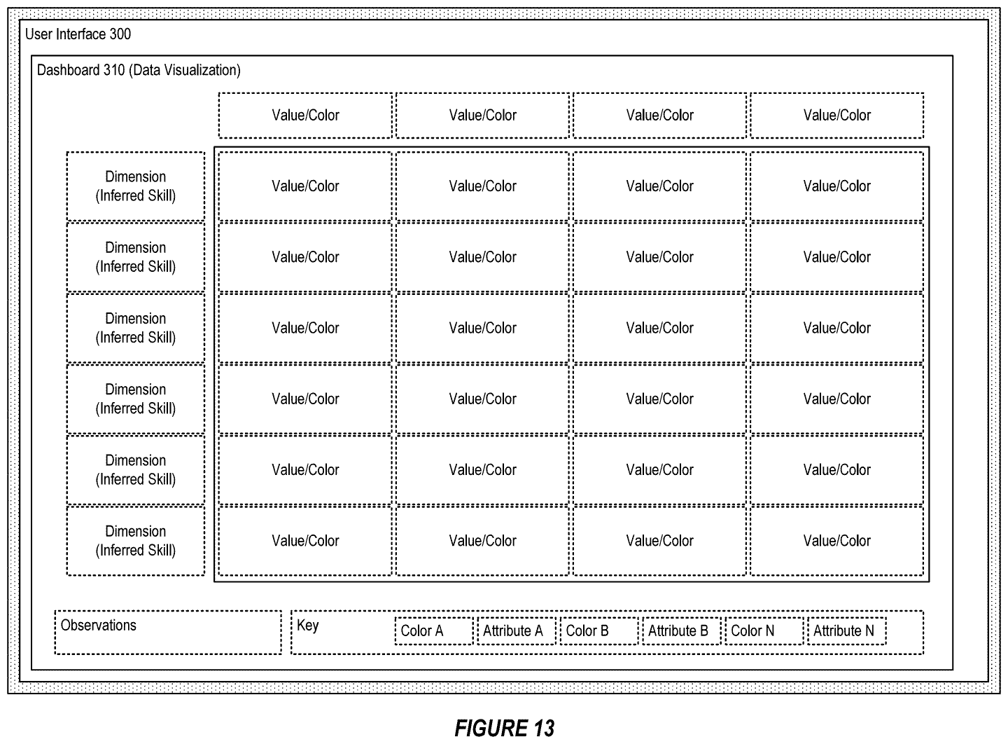

FIGS. 13-18 illustrate how the system can generate data visualizations of inferred characteristics, for example, inferred skills associated with candidates, in accordance with an embodiment.

As illustrated in FIG. 13, in accordance with an embodiment, based on certain conditions the system can indicate within the user interface an analytics dashboard, scorecard, or other data visualization of measures with values or colors. Optionally, the system can display observations or insights related to the data; or can allow a user to drill-down or otherwise interact with the visualization.

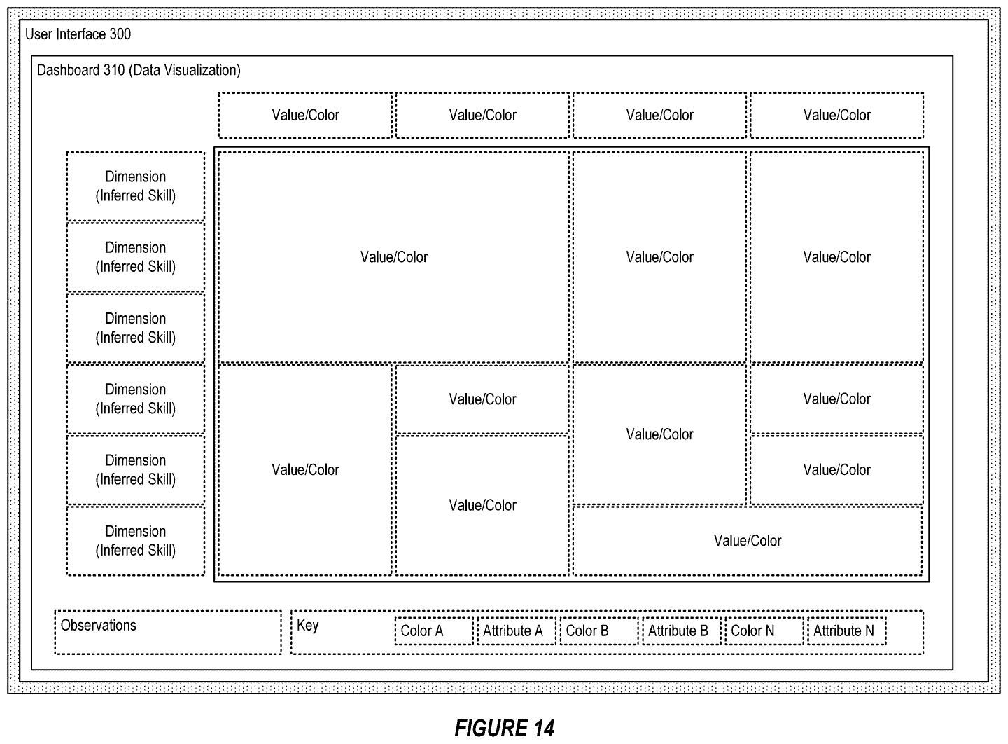

As illustrated in FIG. 14, in accordance with an embodiment, areas within the data visualization indicative of particular inferred characteristics or skills can be sized, or arranged within the data visualization to illustrate their value or magnitude compared with other inferred characteristics or skills.

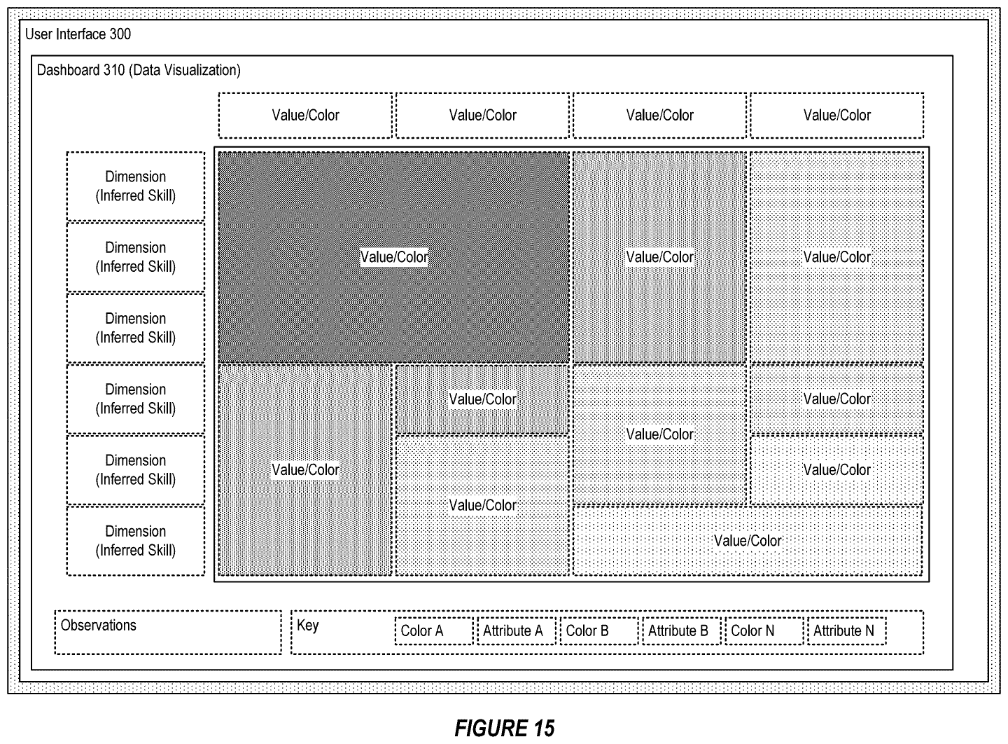

As illustrated in FIG. 15, in accordance with an embodiment, areas within the data visualization indicative of particular inferred characteristics or skills can additionally be shaded or colored within the data visualization to provide contrast, or to illustrate their value or magnitude compared with other inferred characteristics or skills.

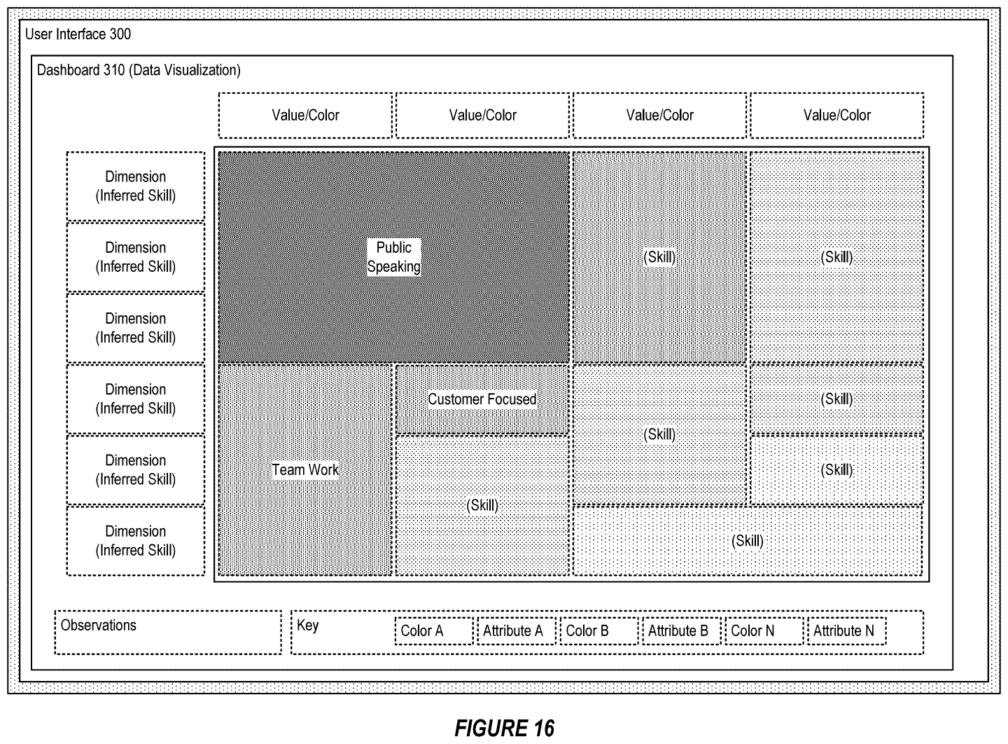

As illustrated in FIG. 16, in accordance with an embodiment, areas within the data visualization indicative of particular inferred characteristics or skills can additionally be labeled with the corresponding characteristic or skill.

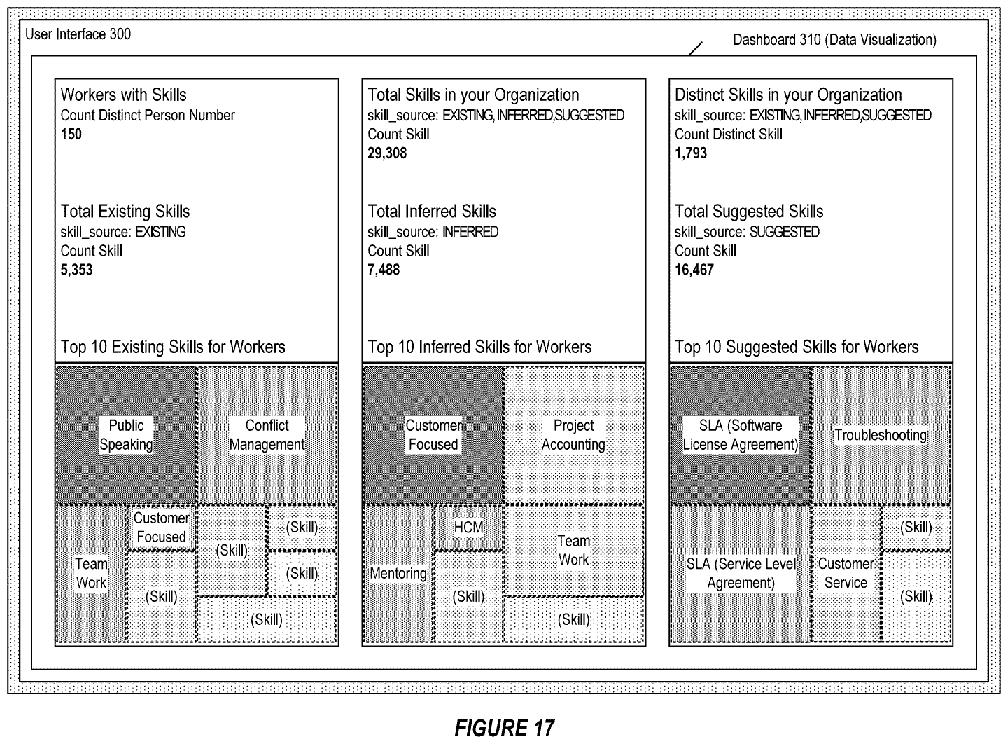

As illustrated in FIG. 17, in accordance with an embodiment, the user interface or analytics dashboard can include multiple data visualizations with areas displayed therein indicative of, in this example, existing skills, inferred skills, and suggested skills.

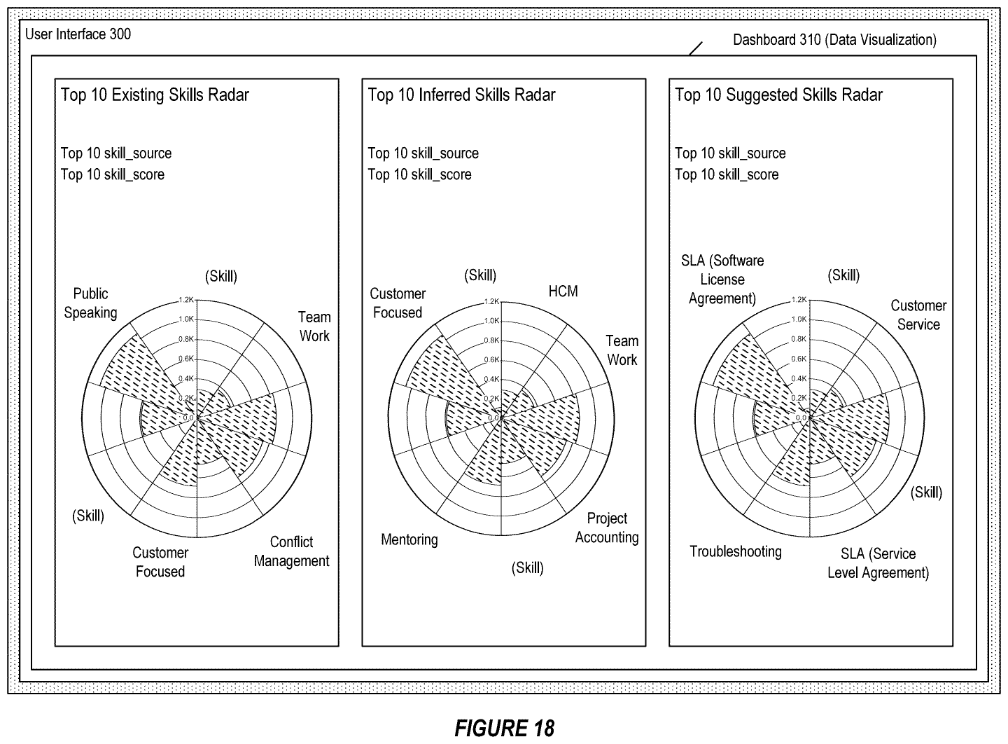

As illustrated in FIG. 18, in accordance with an embodiment, the user interface or analytics dashboard can include different types of data visualizations, in this example a radar chart, with areas displayed therein similarly indicative of, in this example, existing skills, inferred skills, and suggested skills.

The above examples of analytics dashboards, scorecards, or other data visualizations are provided by way of example for purposes of illustrating the various techniques described herein. In accordance with various embodiments, the system can include other types of analytics dashboards, scorecards, or data visualizations useful for indicating and reporting inferred characteristics or skills.

### Inferred Skills Process

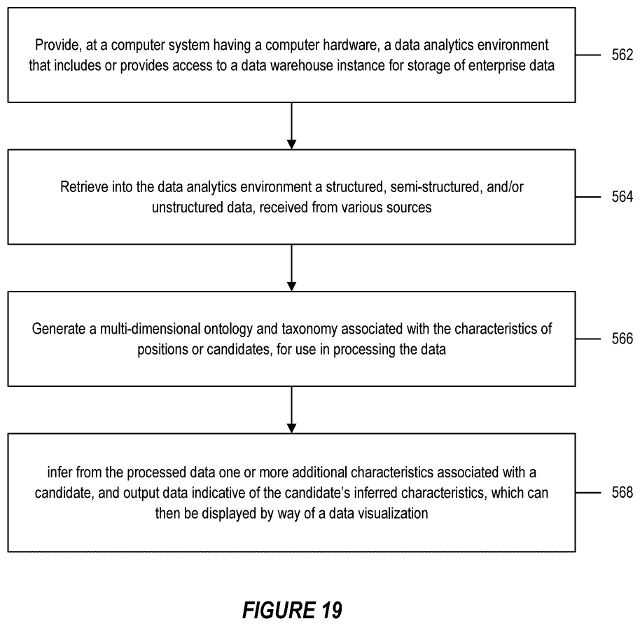

FIG. 19 illustrates an example process or method for generation and use of data models for determination of inferred characteristics associated with candidates, in accordance with an embodiment.

As illustrated in FIG. 19, in accordance with an embodiment, at step 562, the process includes providing, at a computer system having a computer hardware, a data analytics environment that includes or provides access to a data warehouse instance for storage of enterprise data.

At step 564, the system can retrieve into the data analytics environment a structured, semi-structured, and/or unstructured data, received from various sources.

At step 566, the system can generate a multi-dimensional ontology and a taxonomy associated with the characteristics of open positions or potential candidates, for use in processing the received data.

At step 568, the system can then identify from the processed data one or more additional or inferred characteristics associated with a candidate, and output data indicative of the candidate's inferred characteristics, which can then be displayed by way of an analytics dashboard, scorecard, or other data visualization.

For example, in accordance with an embodiment, the described approach can be used to identify a candidate's otherwise-hidden or inferred skills, which in turn provides an organization's HCM/HR department and business leaders with a more complete understanding of their workforce's overall capabilities. For example analytics dashboards, scorecards, or data visualizations as described herein can be used to identify employee skills suitable for planned projects or business goals, undertake initiatives to address potential skill gaps, or support particular groups of employees in their ongoing skill development.

### Example Use Case

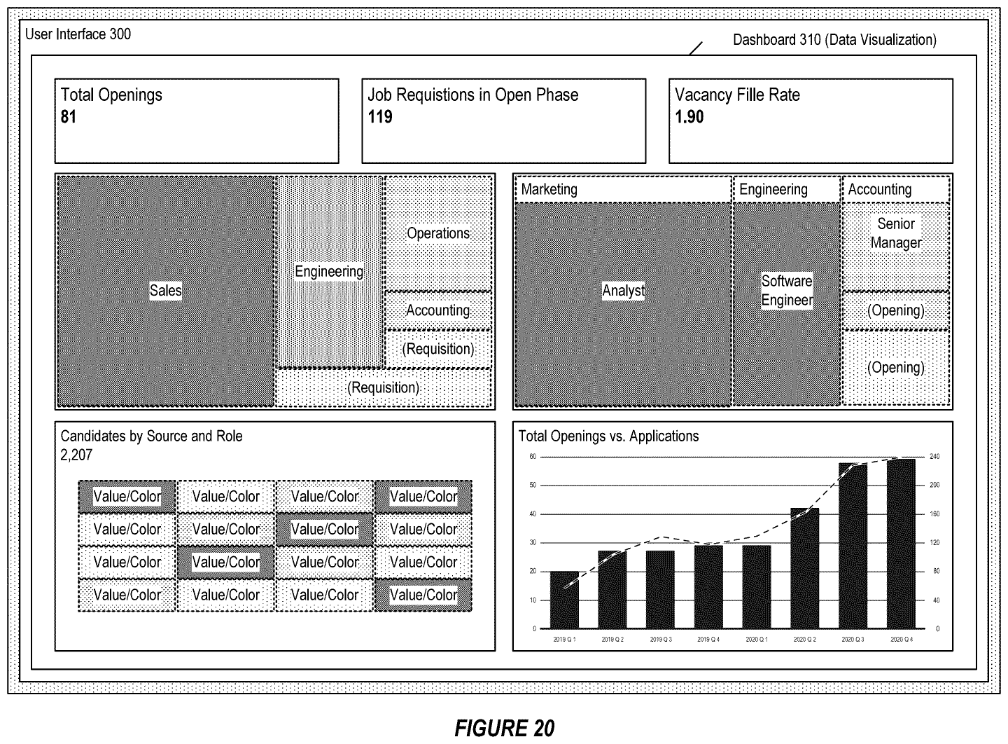

Figures 20-25 Illustrate an Example Use Case of Determining Inferred Skills, in accordance with an embodiment.

In particular, FIGS. 20-25 illustrate an example use case in which a HR professional is tasked with assessing the possibility of onboarding candidates for a software development project due to begin in the coming weeks, and which is expected to require software engineers proficient in Python.

As illustrated in FIG. 20, in accordance with an embodiment, the HR professional can display a talent analytics dashboard that provides at a high level various KPIs of interest, including in this example, open requisitions, job openings by role, and candidates by source and role.

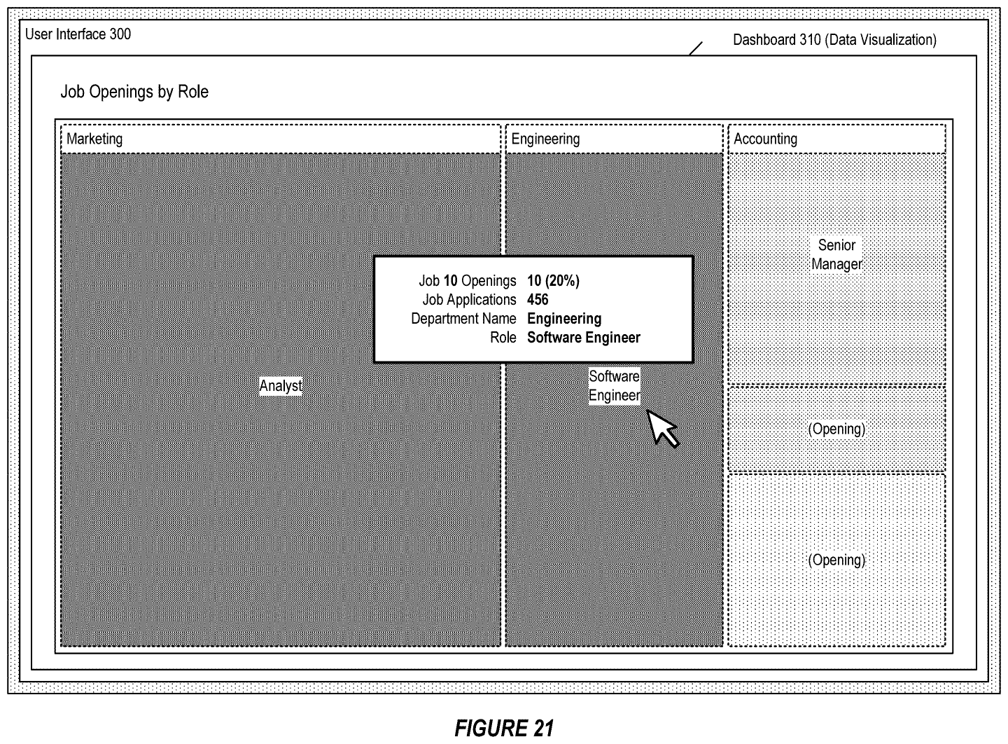

As illustrated in FIG. 21, in accordance with an embodiment, the talent analytics dashboard reveals that the engineering department has the second highest number of open requisitions, with the highest number of job applications being software engineers. Based on this it appears hiring external candidates with python skills may be challenging.

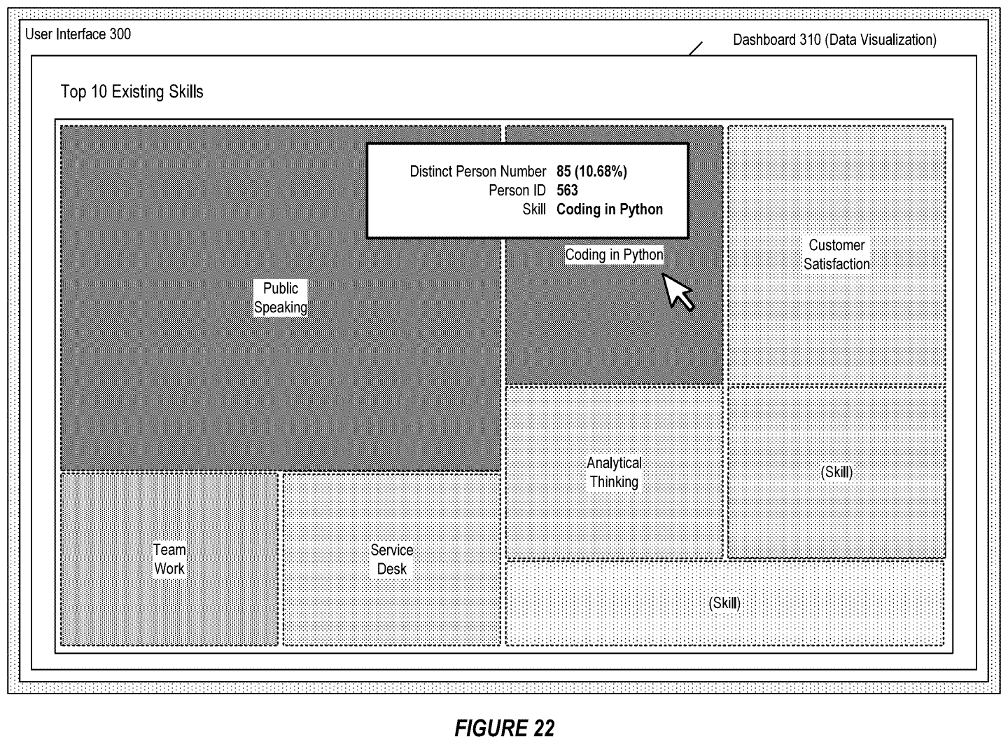

As illustrated in FIG. 22, in accordance with an embodiment, considering internal candidates instead within the organization, the HR professional generates an existing skills analytics dashboard, illustrating the distribution of employee skills across the entire organization, drawn from the employee talent profiles.

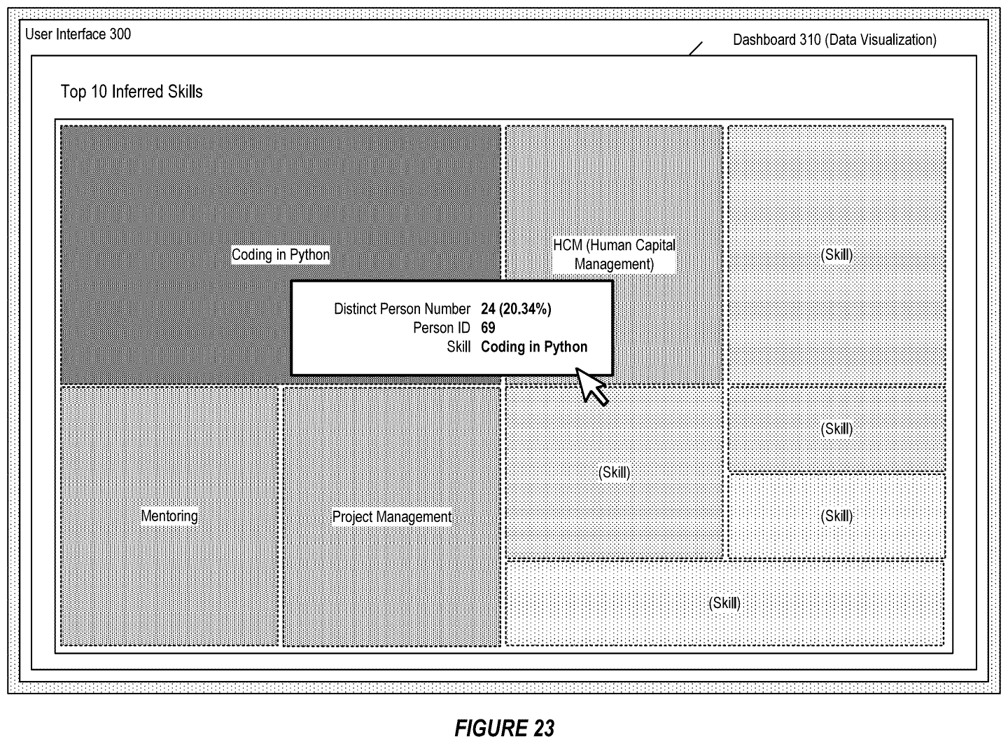

As illustrated in FIG. 23, in accordance with an embodiment, the system can be used to generate inferred and suggested skill sets, using the above-described approach, based on employee job and talent profiles, and ingested additional data where available. Typically these inferred and suggested skills are not visible on the employee's talent profile, but the system suggests they should be included.

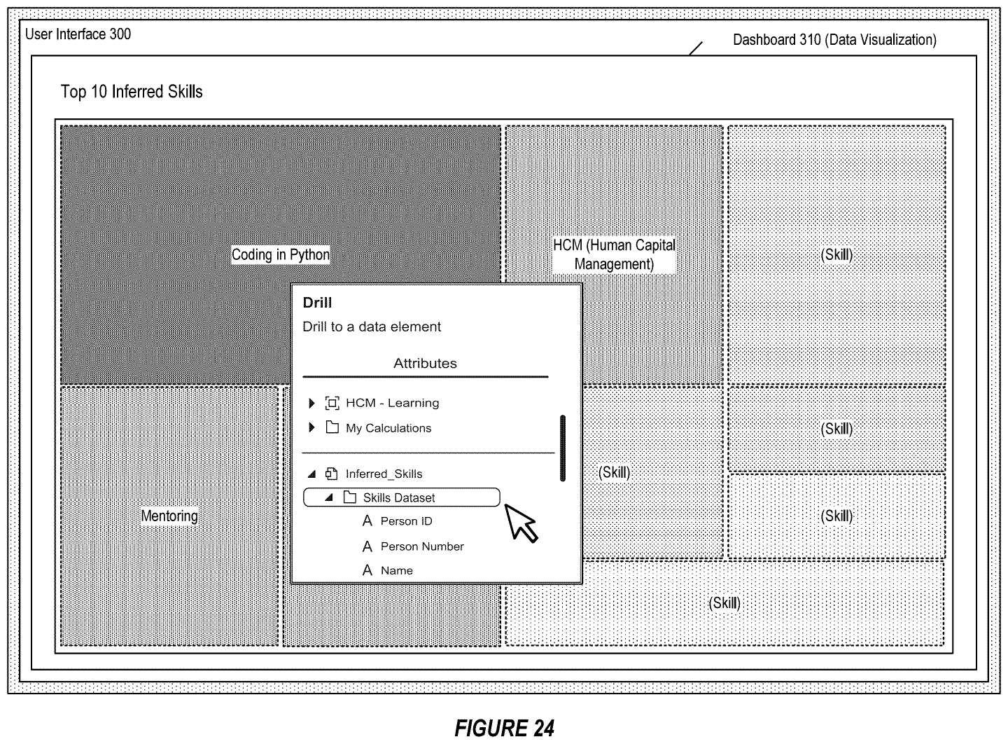

As illustrated in FIG. 24, in accordance with an embodiment, since the HR professional is particularly interested in candidates with Python skills, they can use an interface provided by the system that allows filtering or drilling down within this skill set, in this example to see those candidates for whom the system infers as having Python skills.

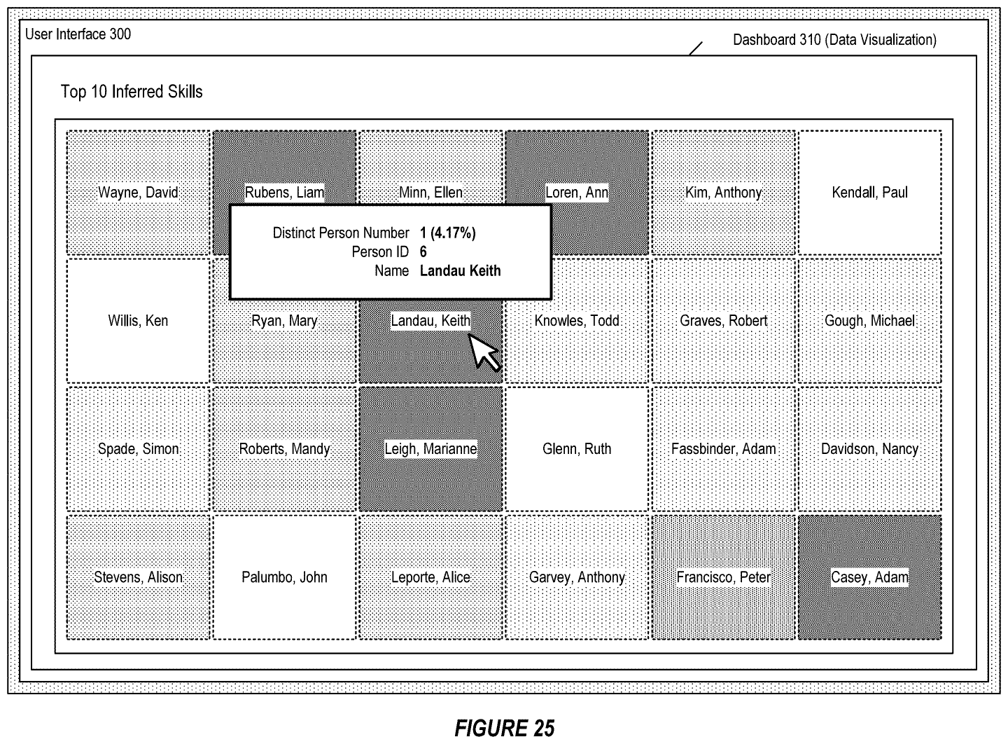

As illustrated in FIG. 25, in accordance with an embodiment, the system can generate an analytics dashboard, scorecard, or other data visualization in which several candidates with Python skills have been determined, either as a known or inferred skill, from which the HR professional can identify and potentially select for use in the upcoming software development project.

### Technical Advantages

In accordance with an embodiment, examples of various technical advantages or use cases supported by the system include:

Maximizing employee potential with better skills utilization: In determining inferred skills, the described approach enables employees to discover new skills to grow their careers. Business managers are better equipped to assess individual and team readiness for planned projects, connect skilled individuals with the right opportunities, and leverage internal talent to fulfill urgent business needs.

Driving strategic workforce planning with better skills-to-title mapping: The described approach supports the application of skills to varying business requirements; and provides skills-to-titles alignment, for example, to narrow a pool of job applicants or candidates for specific positions.

Adapting to industry trends with agile upskilling/reskilling: Business leaders can track and analyze employee skills to address skill gaps; gain insights into skill penetration at every level from the entire organization to specific employees; and make insight-driven decisions regarding the skills they need to develop or invest in.

The above examples of advantages and use cases are provided by way of example for purposes of illustrating the various techniques described herein. It will be evident that in accordance with various embodiments, additional advantages and use cases can be provided, including those generally directed to workforce and individual employee growth, or to address the changing needs of an enterprise organization or business environment.

In accordance with various embodiments, the teachings herein can be implemented using one or more computer, computing device, machine, or microprocessor, including one or more processors, memory and/or computer readable storage media programmed according to the teachings herein. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Further modifications and variations will be apparent to the practitioner skilled in the art.

The embodiments were chosen and described in order to best explain the principles of the teachings herein and their practical application, thereby enabling others skilled in the art to understand the various embodiments and with various modifications that are suited to the particular use contemplated. It is intended that the scope be defined by the following claims and their equivalents.

What is claimed is:

1. A system for generation and use of data models for determination of inferred characteristics associated with candidates, comprising:
a computer system having a computer hardware, a data analytics environment that includes or provides access to a data warehouse instance for storage of enterprise data, wherein the system operates to:
retrieve into the data analytics environment a structured, semi-structured, and/or unstructured data, received from various sources;
generate a multi-dimensional ontology and a taxonomy associated with the characteristics of open positions or potential candidates, for use in processing the received data; and
identify from the processed data one or more additional or inferred characteristics associated with a candidate, and output data indicative of the candidate's inferred characteristics, which is then displayed as a data visualization.

2. The system of claim 1, wherein the system operates to identify a candidate's otherwise-hidden or inferred skills.

3. The system of claim 2, wherein the data is processed by the system using one or more pipelines comprising machine learning data models.

4. The system of claim 3, wherein the machine learning data models operate on:
a position requisition dataset that indicates one or more skills of interest; and
a talent profiles dataset that indicates skills associated with candidate talent profiles.

5. The system of claim 1, wherein the data analytics environment is provided within or as part of a cloud computing environment.

6. A method for generation and use of data models for determination of inferred characteristics associated with candidates, comprising:
providing, at a computer system having a computer hardware, a data analytics environment that includes or provides access to a data warehouse instance for storage of enterprise data;
retrieve into the data analytics environment a structured, semi-structured, and/or unstructured data, received from various sources;
generate a multi-dimensional ontology and a taxonomy associated with the characteristics of open positions or potential candidates, for use in processing the received data and inferring from the processed data one or more additional or inferred characteristics associated with a candidate, and outputting data indicative of the candidate's inferred characteristics, which is then displayed as a data visualization.

7. The method of claim 6, wherein the system operates to identify a candidate's otherwise-hidden or inferred skills.

8. The method of claim 7, wherein the data is processed by the system using one or more pipelines comprising machine learning data models.

9. The method of claim 8, wherein the machine learning data models operate on:
a position requisition dataset that indicates one or more skills of interest; and
a talent profiles dataset that indicates skills associated with candidate talent profiles.

10. The method of claim 6, wherein the data analytics environment is provided within or as part of a cloud computing environment.

11. A non-transitory computer readable storage medium having instructions thereon, which when read and executed by a computer cause the computer to perform a method comprising:
providing, at a computer system having a computer hardware, a data analytics environment that includes or provides access to a data warehouse instance for storage of enterprise data;
retrieve into the data analytics environment a structured, semi-structured, and/or unstructured data, received from various sources;
generate a multi-dimensional ontology and a taxonomy associated with the characteristics of open positions or potential candidates, for use in processing the received data and
inferring from the processed data one or more additional or inferred characteristics associated with a candidate, and outputting data indicative of the candidate's inferred characteristics, which is then displayed as a data visualization.

12. The non-transitory computer readable storage medium of claim 11, wherein the system operates to identify a candidate's otherwise-hidden or inferred skills.

13. The non-transitory computer readable storage medium of claim 12, wherein the data is processed by the system using one or more pipelines comprising machine learning data models.

14. The non-transitory computer readable storage medium of claim 13, wherein the machine learning data models operate on:
a position requisition dataset that indicates one or more skills of interest; and
a talent profiles dataset that indicates skills associated with candidate talent profiles.

15. The non-transitory computer readable storage medium of claim 11, wherein the data analytics environment is provided within or as part of a cloud computing environment.
